(19) United States
(12) Patent Application Publication
(10) Pub. No.: US 2023/0297079 A1
(43) Pub. Date: Sep. 21, 2023

(54) BACK-END PROCESSING SYSTEMS AND METHODS FOR DEVICE IDENTIFICATION

(71) Applicant: Lattice Semiconductor Corporation, Hillsboro, OR (US)

(72) Inventors: Narasimhakumar Mangipudi, Portland, OR (US); Tim Vogt, San Jose, CA (US)

(21) Appl. No.: 18/184,622

(22) Filed: Mar. 15, 2023

Related U.S. Application Data
(60) Provisional application No. 63/269,598, filed on Mar. 18, 2022.

(51) Int. Cl. G05B 19/418

(52) U.S. Cl. CPC G05B 19/4183; G05B 2219/45026; G05B 2219/45027

(57) ABSTRACT

Various techniques are provided to implement back-end processing systems and methods for device identification. In one example, a method includes receiving fabrication data associated with a die element. The die element has an integrated circuit fabricated according to a design defined by a mask set. The method further includes creating, by the integrated circuit, a seed value based on a characteristic of the integrated circuit. The method further includes producing, by the integrated circuit, an identifier for the die element based on the fabrication data and the seed value. Related devices and systems are provided.

### CROSS-REFERENCE TO RELATED APPLICATION

This application claims priority to and the benefit of U.S. Provisional Patent Application 63/269,598 filed Mar. 18, 2022 and entitled “Methods and Systems for Back-End Processing of Immutable and Unique Device Identification,” which is hereby incorporated by reference in its entirety.

### TECHNICAL FIELD

The present invention relates generally to device identification, and more particularly, to back-end processing systems and methods for device identification.

### BACKGROUND

Integrated circuits are fabricated on semiconductor wafers over many process steps. In certain process steps, patterns are created (such as a pattern of deposition, etching, or implantation) based on mask layers of a mask set, which is specific for that integrated circuit. If a mask set for an integrated circuit can be copied, then a “clone” line of manufacturing for that integrated circuit could be created. Additionally, in many situations, a fabless company would own a mask set for a chip that it designed, but has a third-party semiconductor fabrication vendor produce the integrated circuits on its behalf. Therefore, it is possible that unauthorized copies of an integrated circuit could be produced using the same mask set. These situations are referred to as “cloning” in this disclosure.

### SUMMARY

Cloning presents financial risks for a company. Creating a complex integrated circuit (IC) design represents tens, if not hundreds of millions of dollars of investment, and one embodiment of that IC design is represented by a mask set that can be used to produce it. Therefore, if a third party could have additional chips produced using that mask set, which were not authorized by or do not benefit the company, that may result in revenue losses. It is possible to duplicate a mask set, and a duplicate mask set may allow an entire alternate production line of unauthorized copies to be created. This clearly would financially impact the company. Further, in some situations, some of the integrated circuits on a given wafer may prove to be not fully functional. The company may desire to scrap or downbin these parts, but in some cases a third party may salvage them and package the scrap parts as fully-functional parts. These situations create or exacerbate downstream supply chain risks, because these unauthorized versions of the integrated circuit design could be less functional than a true copy and/or could be intentionally compromised in some way. These situations thus create reputational and financial risks for a semiconductor company itself, as well as risks for customers of the semiconductor company.

Aspects of the present disclosure relate to methods, integrated circuits, and systems that address cloning, either within the same fab or using a copied mask set in a different fab, and/or introduction of unauthorized salvage of scrapped parts into a company's supply chain. In integrated circuit production, after the fabrication of the integrated circuits on the wafer, a back-end processing of the wafer is performed.

In some embodiments, methods performed in and with an integrated circuit and such ICs increase a difficulty of cloning the IC (e.g., making unauthorized copies on the production line and/or duplicating the mask set for use on a different production line). In one aspect of the disclosure, a method is performed by an IC during back-end processing that includes receiving fabrication information specific to a distinct die element that is taken from a semiconductor wafer. The die element (die) has an integrated circuit fabricated according to a design defined by a mask set. The IC stores in non-volatile memory on the die element the fabrication information and creates a high-entropy, repeatable seed value based on physical characteristics of the integrated circuit as fabricated. The IC processes the fabrication information and the high-entropy seed value using a cryptographic function to produce an identifier for the die element. The IC is responsive to an external (to the IC) command by providing the identifier and optionally the fabrication information. In some implementations, the command may be provided to the IC from a tester, which also supplies the fabrication information that is stored in the non-volatile memory. In some implementations, the tester can be located in a secured facility. In some implementations of the IC, the IC is equipped with anti-tamper monitoring logic that ensures stability of temperature and voltage during performance of sensitive operations by the IC. The IC also may lock all external ports during creation of the seed value and the processing of the fabrication information and the seed value to produce the identifier, and then unlock the ports after completing the processing. Other aspects include a die element with an integrated circuit that performs methods according to the disclosure, and systems that include a tester and database functionality that records each ID of each integrated circuit along with other information, such as the fabrication information for that IC and in some cases information obtained during testing of the device (such as speed grading and so on).

### BRIEF DESCRIPTION OF THE DRAWINGS

FIG. 1 illustrates a system for facilitating back-end processing for device identification in accordance with one or more embodiments.

FIG. 2 illustrates a flow for creating and processing die elements in accordance with one or more embodiments of the present disclosure.

FIG. 3 illustrates an example block-level diagram of an integrated circuit for facilitating back-end processing for device identification in accordance with one or more embodiments of the present disclosure.

FIGS. 4 and 5 each illustrate a flow diagram of an example process for facilitating back-end processing for device identification in according with one or more embodiments of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

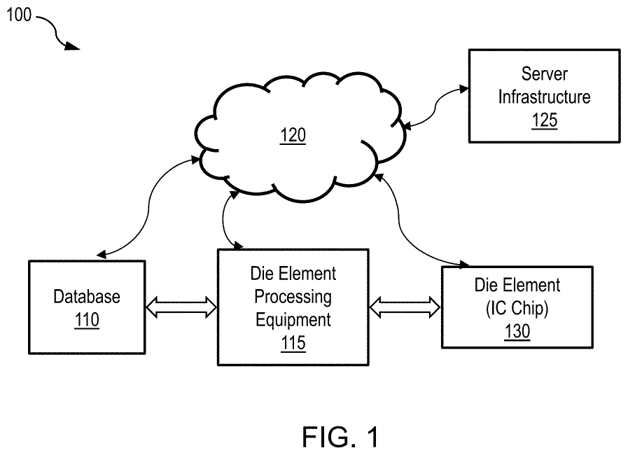

FIG. 1 depicts a system 100 for facilitating back-end processing for device identification in accordance with one or more embodiments. The system 100 includes a database 110, die element processing equipment 115, a network 120, a server infrastructure 125, and a die element 130. The die element processing equipment 115 may be, may include, may be a part of, and/or may be referred to as automated testing equipment (ATE) and/or programming equipment. In some cases, the die element processing equipment 115 may be located at an assembly/test facility. The database 110 may store data from the die element processing equipment 115 and/or store data for retrieval by the die element processing equipment 115. The database 110 may communicate over the network 120 with the server infrastructure 125 (e.g., a company's server infrastructure and/or facilities). In an aspect, the database 110 may be located behind or in the server infrastructure 125, and/or the die element processing equipment 115 may communicate through networking equipment with the server infrastructure 125 such that data may be stored in the database 110 in such a scenario. The die element processing equipment 115 couples with the die element 130 (e.g., to perform operations on and/or with the die element 130). The die element 130 includes an integrated circuit that was fabricated according to a design defined by a mask set (e.g., along with processing steps defined by a particular semiconductor fabrication process, as is known in the arts). In an embodiment, a fabricated semiconductor product may refer to the die element 130 or the integrated circuit fabricated on the die element 130. In an embodiment, a fabricated semiconductor product, a die element, and an integrated circuit may each be referred to as a device.

In some embodiments, the die element 130 (e.g., or, generally equivalently, the integrated circuit fabricated on the die element 130) may be enrolled to the die element processing equipment 115 and/or the database 110. In some aspects, enrollment of each die element (e.g., each integrated circuit) may involve recording an identifier (e.g., also referred to as a device identifier) of each die element to associate the die element with a specific semiconductor company and/or mitigate effects of cloning. In this regard, the die element or the integrated circuit fabricated thereon is a device that can be identified using the identifier. For example, the identifier associated with the die element 130 can be used to associate the die element 130 with a specific semiconductor company (e.g., a legitimate/authorized production line of the specific semiconductor company). In some cases, other information may be recorded (e.g., in the database 110) along with the identifier. For example, along with the identifier for a given die element, fabrication data for the die element and, in some cases, data obtained during testing of the die element (e.g., speed grading) may also be recorded.

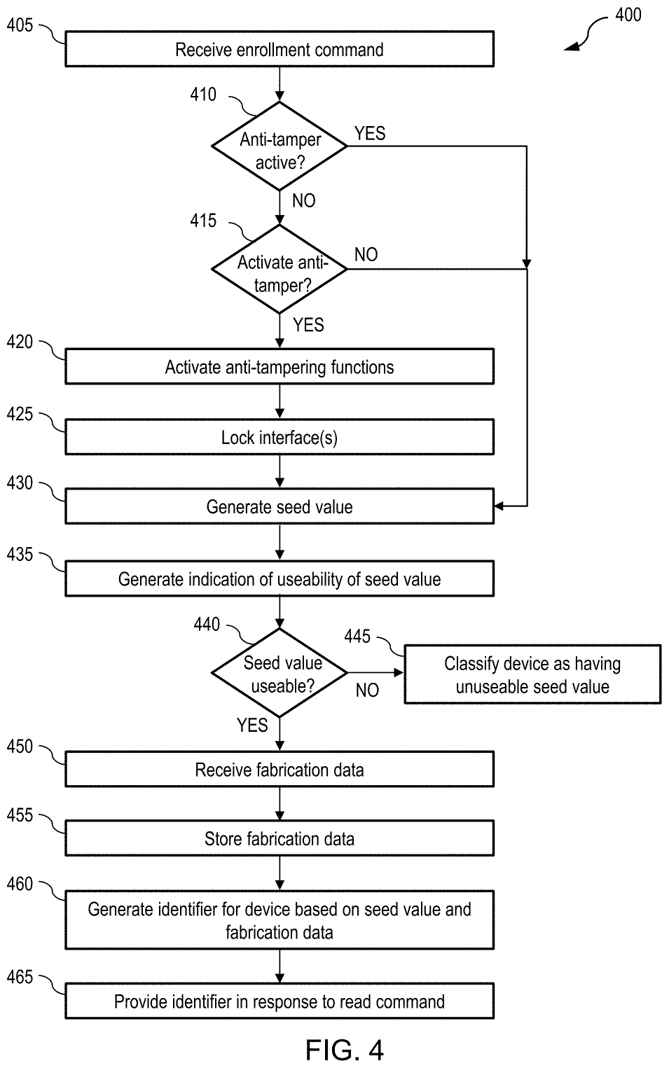

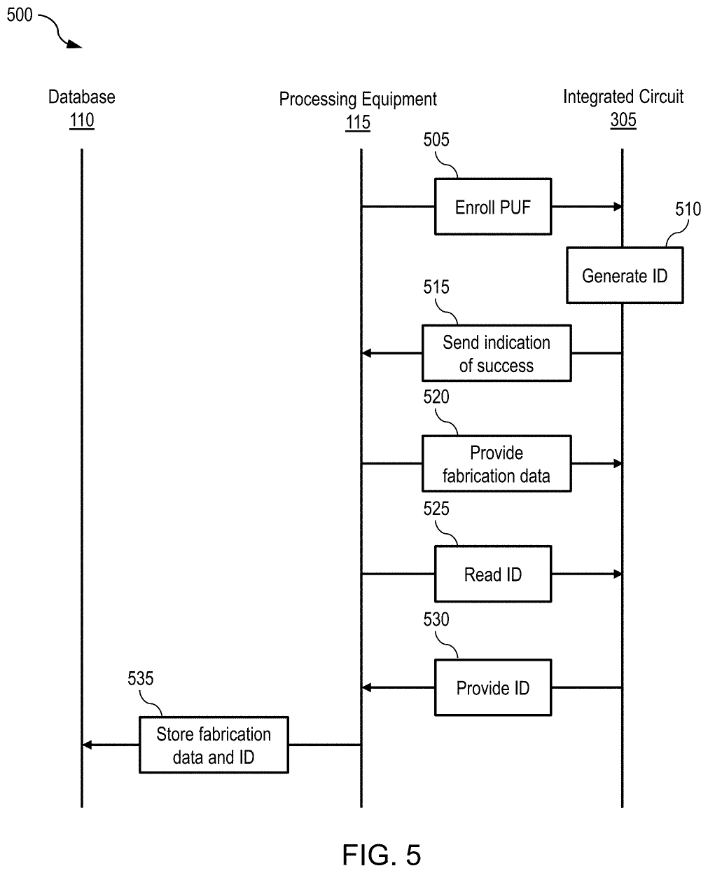

In some embodiments, the processing equipment 115 may send a command (e.g., also referred to as an instruction or request) to the die element 130 to initiate enrollment of the die element 130. In some cases, the command may be referred to as an enrollment command/instruction/request. As further described with respect to FIGS. 4 and 5, such enrollment may include generating, by the die element 130, an identifier associated with the die element 130 in response to the command from the processing equipment 115 and associated operations. The die element 130 may provide the identifier to the processing equipment 115, such as in response to a read command/instruction/request from the processing equipment 115 to the die element 130 for the identifier. The processing equipment 115 may store the identifier and, in some cases, associated data (e.g., fabrication data, testing data such as testing results). In some aspects, the identifier and/or other associated data may be accessed later to confirm enrollment of the die element 130 (e.g., to mitigate effects of cloning).

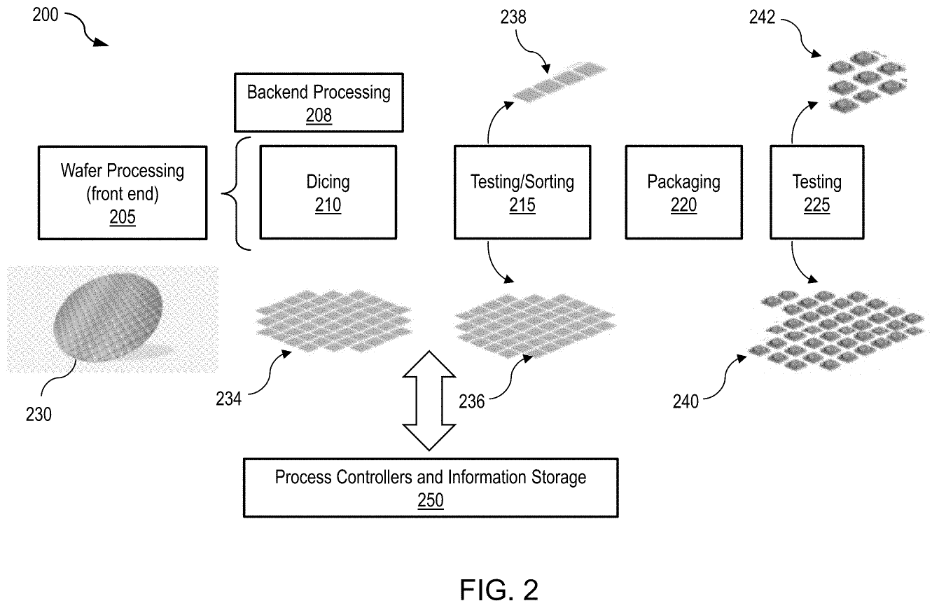

FIG. 2 illustrates a flow 200 for creating and processing die elements in accordance with one or more embodiments of the present disclosure. In some embodiments, the die elements may include, among other die elements, the die element 130 of FIG. 1. It is noted that FIG. 2 is provides high level description for context on creation and processing of die elements that each contain an integrated circuit. One or more operations (e.g., also referred to as blocks, processes, steps, methods) may be combined, omitted, and/or performed in a different order as desired.

The flow 200 includes an integrated circuit (IC) fabrication process/step 205 (e.g., also referred to as wafer processing or front-end wafer processing) performed on a semiconductor wafer 230. In modern processes, the IC fabrication process 205 generally includes many individual steps including, by way of non-limiting examples, various etching, masking, lithography, and implantation steps to form/fabricate the ICs. After the fabrication process 205 is complete (e.g., the ICs have been formed/fabricated on the wafer 230), a back-end process/step 208 can begin. The back-end process 208 performed on the wafer 230 may include, by way of non-limiting examples, a dicing/singulation process/step 210 that dices the wafer 230 into individual die elements 234 (e.g., also referred to as distinct die elements, discrete die elements, or separate die elements). Each die element from (e.g., obtained by dicing) the wafer 230 includes an integrated circuit.

In some post-fabrication flows, such as shown in FIG. 2, after the dicing process 210, the resulting die elements 234 can undergo one or more rounds of testing and sorting 215. In some flows, some testing may be done on die elements before the dicing step 210. In some cases, such testing/sorting processes 215 may begin with electrical tests (e.g., basic electrical tests) and/or other tests for testing the functionality of the die elements 234 as would be understood by one skilled in the arts. The die elements 234 (e.g., the IC formed on each of the die elements 234) may generate a test result(s) in response to an electrical testing of the die elements 235. The electrical testing may involve a test signal(s) applied (e.g., by a tester such as the die element processing equipment 115) on the die elements 234. The testing/sorting processes 215 on the die elements 234 may result in identification of a set of die elements 236 that pass the testing (e.g., referred to as good die elements) and a set of die elements 238 that failed the testing (e.g., referred to as bad die elements or scrap). Test results for a given die element of the die elements 234 may be compared with one or more thresholds (e.g., predetermined threshold(s)) to identify/classify/sort the die element as being a good die element or a bad die element. The threshold(s) may generally be set dependent on application.

After the testing/sorting process 215, a packaging process/step 220 may be performed on the set of die elements 236 (e.g., the good die) to package them. A further testing processing/step 225 may be performed on the packaged die elements to identify a set of packaged die elements 240 (e.g., referred to as good packaged die elements) and a set of packaged die elements 242 (e.g., referred to as bad packaged die or scrap). Such testing may include electrical tests and/or other tests for testing the functionality of the packaged die elements as would be understood by one skilled in the arts. Test results for a given packaged die element may be compared with one or more thresholds (e.g., predetermined threshold(s)) to identify/classify/sort the die element as being a good packaged die element or a bad packaged die element. The threshold(s) may generally be set dependent on application. In some cases, such testing may include testing similar to or the same as the testing 215 performed on the die elements 234 and/or testing different from the testing 215 performed on the die elements 234. It is noted that there may or may not be scraps (e.g., the set of die elements 238 or the set of packaged die elements 242) resulting from any given wafer, as the various processes/steps of the flow are performed with goals to minimize scrap and maximize yield. In some embodiments, the back-end process 208 may include the processes 205, 210, 215, 220, and 225.

In an embodiment, a fabricated semiconductor product may refer to any one of various stages of a die element having an IC formed thereon or the IC itself at any one of these various stages. In this regard, a fabricated semiconductor product may refer to a die element of a wafer (e.g., the wafer 230) prior to dicing of the wafer, a die element after dicing of the wafer (e.g., one of the die elements 234), a die element after packaging (e.g., one of the packaged die elements 240 or 242), a die element at an intervening stage or at a stage subsequent to packaging, or an IC on the die element at any one of these various stages.

Process controllers and information storage 250 may be used facilitate one or more of the processes 205, 210, 215, 220, and/or 225. Process controllers may include one or more processors, one or more sensors, and/or other components for providing one or more control signals to equipment for performing the processes 205, 210, 215, 220, and/or 225 and/or monitoring performance of the processes 205, 210, 215, 220, and/or 225. The process controllers may adjust (e.g., autonomously adjust and/or adjust based on user input) processes in real time and/or set alerts (e.g., for a human operator and/or an autonomous controller) when an issue is detected (e.g., to determine whether or how to mitigate the issue or abort the flow 200). In some cases, the process controllers may receive user input that sets parameters for the processes 205, 210, 215, 220, and/or 225 and/or mitigates any issues detected when performing the processes 205, 210, 215, 220, and/or 225. Information storage may include memory devices (e.g., volatile memory and/or non-volatile memory) for storing data used in the process 205 (e.g., etching parameters, masks to apply, materials to use, etc.), 210 (e.g., locations to cut the wafer 230), 215 (e.g., testing parameters, thresholds for identifying a die element as being good or bad), 220, and/or 225. By way of non-limiting examples, the data used for the process 205 may include etching parameters, masks to apply, materials to use, etc.; for the process 210 may include locations to cut the wafer 230; for the processes 215 and 225 may include testing parameters, thresholds for identifying a die element as being good or bad, etc.; and so forth.

In semiconductor fabrication flows according to one or more embodiments of the present disclosure, wafers are individually identifiable. By way of non-limiting examples, such identification may be based on an identifier on (e.g., associated with) the wafer itself, counting a number of wafers processed for a particular integrated circuit design at a particular fabrication facility, and/or other factors/parameters.

In implementations according to one or more embodiments of the present disclosure, each die element produced according to a particular fabrication process may be individually identifiable. In this regard, each die element on each wafer may be individually identifiable. In some aspects, each die element (e.g., such as the die element 130) on each wafer (e.g., such as the wafer 230) may be identified, by way of non-limiting examples, using a coordinate pair (e.g., “X/Y” coordinates) that identifies from what part/location of a wafer a particular die element was obtained and/or identification (e.g., identifier and/or wafer number indicative of a number of wafers processed) associated with a wafer from which a particular die element was obtained.

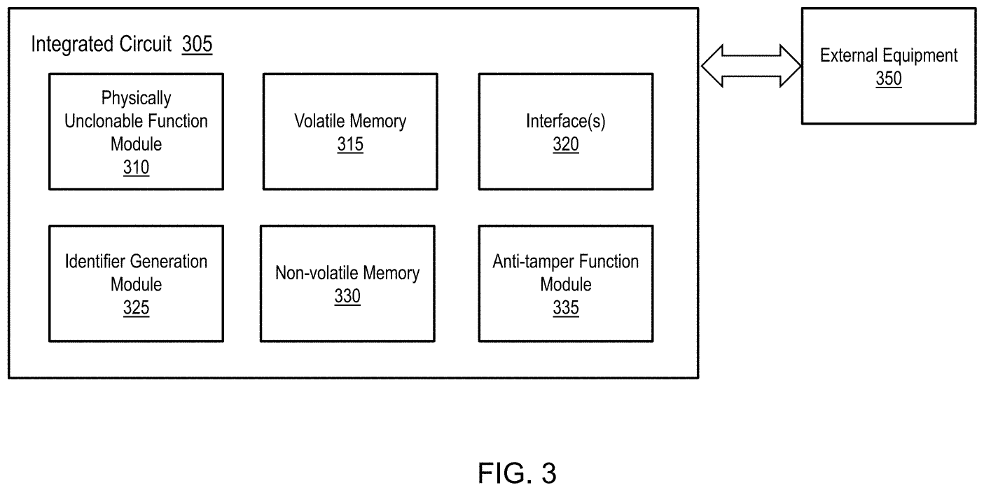

FIG. 3 depicts an example block-level diagram of an integrated circuit 305 for facilitating back-end processing for device identification in accordance with one or more embodiments of the present disclosure. The integrated circuit 305 is formed on a die element (e.g., the die element 130). In some embodiments, the die element may result from the flow 200 according to FIG. 2. The integrated circuit 305 includes a physically unclonable function (PUF) 310 logic module/device/circuit (e.g., a memory-based PUF logic module/device/circuit or a module/device/circuit based on other PUF technologies), an identifier (ID) generation module/device/circuit 325 (e.g., also referred to as an ID module/device/circuit), a volatile memory 315, a non-volatile (NV) programmable memory 330, and one or more interfaces 320 for interfacing externally with the integrated circuit functionality. The volatile memory 315 may be optional, such that the volatile memory 315 may be provided in some implementations and not others. In some cases, the volatile memory may be or may include random access memory (RAM). The RAM may include static RAM, resistive RAM, and/or other memory types/functionality. In some cases, the non-volatile memory 330 may include one-time programmable (OTP) memory. The interface(s) 320 may communicate with external equipment 350. In some cases, the external equipment 350 may include the die element processing equipment 115.

In some embodiments, the PUF logic module 310 may use unique fabrication characteristics, such as artifacts or mesoscopic variations in how materials are deposited while fabricating each die element on the wafer 230, to produce (e.g., create, generate) a repeatable, high-entropy seed value. In this regard, physical characteristics of the integrated circuit 305 may be used to produce the seed value. In some embodiments, the seed value is not explicitly stored in a memory or other mechanism of encoding. In some implementations, the PUF logic module 310 uses such variations within the context of the volatile memory 315 (e.g., an SRAM).

In some aspects, as shown in FIG. 3, the integrated circuit 305 includes an optional anti-tamper (AT) logic module/device/circuit 335 for providing AT functionality. In some cases, the AT functionality may include functionality to detect attempts to modify operation of the IC 305. As non-limiting examples, the AT functionality may include voltage and temperature stability and value monitoring to detect such operation modification attempts. In some cases, the voltage and/or temperature monitoring of the IC 305 determines whether or not to proceed with operations in back-end processing of the die element. For example, operations such as generating a seed value and/or generating an identifier may be performed when (e.g., conditioned upon) the temperature and/or the voltage being maintained within defined ranges/parameters (e.g., indicative of no or minimal potential tampering). The AT logic module 335 may be active always or may be activated during sensitive operations. In some cases, a user and/or a manufacturer of the integrated circuit 305 may set when the AT module 335 is active.

According to various embodiments, each logic module/device/circuit may include one or more of a processor, a microprocessor, a central processing unit (CPU), a graphics processing unit (GPU), a single-core processor, a multi-core processor, a microcontroller, a programmable logic device (PLD) (e.g., field programmable gate array (FPGA)), an application specific integrated circuit (ASIC), a digital signal processing (DSP) device, or other logic device that may be configured, by hardwiring, executing software instructions, or a combination of both, to perform various operations discussed herein for embodiments of the present disclosure. The volatile memory 315 and the non-volatile memory 330 may be used to store data received from the logic modules and/or store data for retrieval by the logic modules. In some cases, the integrated circuit 305 may include a controller logic module/device/circuit (not shown) for controlling operation of the PUF logic module 310, the volatile memory 315, the non-volatile memory 330, the ID generation module 325, the AT logic module 335, and/or the interface(s) 320. In other cases, functionality of such a controller logic module/device/circuit may be distributed across multiple logic modules, such as the PUF logic module 310, the ID generation module 325, and/or the AT logic module 335. In some aspects, the PUF logic module 310, the identifier generation module 325, and/or the anti-tamper-function module 335 may be collectively referred to as a logic circuit, a logic device, a logic module, and the like.

In some implementations, the volatile memory 315 may contain portions of memory that are used for data storage, and other portions that are used by the PUF logic module 310; these portions may be integrally or separated on a given die element. Characteristics of a seed value may include its repeatability and its entropy. Such characteristics may define a health/useability of a seed value. In an aspect, a seed value may be referred to as being repeatable when the seed value can be produced by the PUF logic module 310 if and/or when the seed value is needed or desired. In some cases, the seed value is repeatable so that it does not need to be explicitly stored in a memory of the IC 305. The ID generation module 325 may interface with the PUF logic module 310 to receive the seed value. In some cases, the ID generation module 325 may also receive an indication of the useability (e.g., also referred to as health) of the seed value. The indication may be referred to as a health indicator, a health score, a useability indicator, a useability score, a quality indicator, a quality score, and the like associated with the seed value. In some cases, the useability of a seed value is dependent on application and may be based on its repeatability and/or its entropy. For the seed value to be useful in certain cryptographic operations, the seed value may need to be formed from sufficiently high-entropy data. In an aspect, high entropy of a seed value associated with a given die element can be conceptualized/characterized as having a desired amount of randomness or decorrelation with respect to seed values associated with all of the other/remaining die elements that would be fabricated by the same mask set. Or stated otherwise, it would be unlikely (e.g., unlikely corresponding with a probability consistent with a desired/particular application) that any two die elements would result in the same seed value produced by the PUF 310. In some embodiments and for explanatory purposes, the seed value would be random and unique, in which a probability of the PUF logic module 310 outputting the same seed value for any two die elements is negligibly small so as to be regarded as effectively zero. It is noted that different applications may call for different probabilities of uniqueness. In some embodiments, the PUF logic module 310 may use physical characteristics, such as artifacts or mesoscopic variations in how materials are deposited while fabricating each die element on the wafer 230, to produce a repeatable, high-entropy seed value.

In one or more embodiments of the present disclosure, the ID generation module 325 may use the seed value from the PUF logic module 310 as an input to a cryptographic function (e.g., one-way hash function) to produce (e.g., create, generate) an identifier (ID) for the die element. In some cases, the ID generation module 325 may also use fabrication data for the die element on which the given IC 305 is formed as an input to the cryptographic function. For example, the fabrication data may be based on, or otherwise encode or represent, a wafer identifier and/or an X/Y coordinate of the die element on a wafer (e.g., the wafer 230). In such manner, in some embodiments, the fabrication data would be unique relative to all die elements legitimately produced on a given semiconductor processing fabrication line. This fabrication information, in conjunction with the seed value, provides further confidence that the identifier output of the cryptographic function for a given die element is different from the identifier output of the cryptographic function for all other die elements.

FIG. 4 depicts a flow diagram of an example process 400 for facilitating back-end processing for device identification in accordance with one or more embodiments of the present disclosure. The process 400 of FIG. 4 assumes that IC 305 is powered (such as from the die element processing equipment 115). Although the process 400 is described with reference to the IC 305 of FIG. 3 for explanatory purposes, the process 400 may be performed by other ICs. The IC 305 for performing the process 400 may be on a die element prior to dicing of a wafer on which the die element is fabricated, on a die element after dicing of the wafer (e.g., one of the die elements 234), on a die element after packaging (e.g., one of the packaged die elements 240 or 242), or on a die element at an intervening/intermediate stage or at a stage subsequent to packaging. In some embodiments, the process 400 may be performed by an IC of each die element from a semiconductor wafer. One or more blocks (e.g., also referred to as operations, processes, steps, methods) may be combined, omitted, and/or performed in a different order as desired.

At block 405, the IC 305 may receive a command (e.g., also referred to as an instruction or request) to enroll the IC 305 (e.g., the PUF logic module 310 of the IC 305). In some cases, the command may be provided to the IC 305 from a tester (e.g., the processing equipment 115). In some cases, such a command/instruction/request may be referred to as an enrollment command/instruction/request. As further described with respect to the process 400, such enrollment may include generating an identifier associated with a die element. In some cases, the command may indicate a time to begin seed generation. In an embodiment, such enrollment may be of the IC 305 (e.g., or portion thereof such as the PUF logic module 310) to the processing equipment 115, the database 110, and/or other entity so as to associate the IC 305 with an identifier that, in turn, can be used to associate the IC 305 with a specific semiconductor company (e.g., a legitimate/authorized production line of the specific semiconductor company).

At block 410, a determination or decision is made as to whether AT functions are active (e.g., also referred to as activated). In some cases, the AT logic module 335 and/or other logic device/module of the IC 305 may have appropriate functionality to determine whether the AT functions are active. If AT functions are determined to not be active, the process 400 proceeds from block 410 to block 415. If AT functions are determined to be active, the process 400 proceeds from block 410 to block 430. In the case the AT functions are determined to be active, the IC 305 may already (e.g., prior to block 410) be performing AT functions such as those at blocks 420 and 425.

In some cases, the AT functionality may include functionality to detect attempts to modify operation of the IC 305. As non-limiting examples, the AT functionality may include voltage and temperature stability and value monitoring to detect such operation modification attempts. The voltage and/or temperature monitoring of the IC 305 may factor into determining whether or not to proceed with remaining blocks in the process 400 (e.g., due to any potential tampering detected and/or potential for tampering). In this regard, operations such as generating a seed value (e.g., block 430) and/or generating an identifier (e.g., block 460) and/or any associated and/or intermediate operations (e.g., between blocks 430 and 460) may be performed when (e.g., conditioned upon) the temperature and/or the voltage being maintained within defined ranges/values/parameters (e.g., indicative of no or minimal probability of tampering).

At block 415, a determination or decision is made (e.g., by the AT module 335 and/or other component of the IC 305) as to whether to activate AT functions. In some cases, such a determination/decision is generally application-dependent and may be based on user input (e.g., user provided parameters) and/or pre-determined parameters for a desired application. As an example, if the process 400 is being performed in an unsecured assembly/test facility and it is desired (e.g., by the manufacturer of the IC 305) to provide precaution (e.g., sufficient or maximum precaution dependent on application) against tamper, the determination or decision may be to activate the AT functions. If the determination is to activate the AT functions, the process 400 proceeds from block 415 to block 420. If the determination is to not activate the AT functions, the process 400 proceeds from block 415 to block 430.

At block 420, the IC 305 (e.g., the AT module 335) activates AT functions of the AT module 335. As provided above, the AT functions may include voltage and/or temperature monitoring to detect for attempts to modify operation of the IC 305. At block 425, the IC 305 locks the interface(s) 320 from input and/or output. In some cases, locking of the interface(s) 320 may be considered an AT function. In some cases, the IC 305 may lock one or more interfaces (e.g., all external interfaces in some cases) during generation of the seed value (e.g., block 430), generation of the identifier (e.g., block 460), and/or any associated and/or intermediate operations (e.g., between blocks 430 and 460). For example, if the process 400 were being performed in an unsecured assembly/test facility, then using the AT functions 335 and port locking may be desirable for security purposes (e.g., as a precaution against tampering).

At block 430, the IC 305 (e.g., in the PUF logic module 310) creates (e.g., generates) a seed value based on characteristics of the IC 305 as fabricated. In some aspects, the characteristics may include physical characteristics (e.g., unique fabrication characteristics) of the IC 305. In an aspect, the IC 305 (e.g., the PUF logic module 310) may produce a repeatable, high-entropy seed value based on such physical characteristics. By way of non-limiting examples, such physical characteristics may include artifacts or mesoscopic variations in how materials are deposited while fabricating each die element, including the die element on which the IC 305 is fabricated, on a wafer (e.g., the wafer 230).

At block 435, the IC 305 (e.g., in the PUF logic module 310) generates an indication of the useability of the seed value generated at block 430. In some cases, block 435 may be optional. In some cases, the PUF logic module 310 sends the indication to the ID generation module 325 (e.g., as a confirmation that the seed value can or cannot be used to generate an identifier for the IC 305).

In some aspects, the useability of a seed value may be based on its entropy and/or its repeatability. In some cases, the indication of the useability may be referred to as and/or represented by a useability score or a health score. In some cases, the indication of the useability may be qualitative (e.g., “high useability,” “medium useability,” “low useability) and/or quantitative (e.g., according to a numerical value/score indicative of useability). In some cases, a seed value may be referred to as being repeatable when the seed value can be produced by the PUF logic module 310 if and/or when the seed value is needed or desired. With regard to entropy, for the seed value to be useful in certain cryptographic operations, the seed value may need to be formed from sufficiently high-entropy data, such as data based on physical characteristics of the IC 305. In an aspect, high entropy of seed values associated with die elements would make it unlikely (e.g., unlikely corresponding with a probability consistent with a desired/particular application) that any two die elements would result in the same seed value produced by their respective PUF logic module 310. In some embodiments, the seed value is random and unique, in which a probability of the PUF logic module 310 outputting the same seed value for any two die elements is negligibly small so as to be regarded as effectively zero. It is noted that different applications may call for different probabilities of uniqueness.

At block 440, a determination or decision can be made as to whether the seed value is useable (e.g., also referred to as healthy) or not based on the indication. In some cases, the determination or decision may be made by the ID generation module 325 based on the indication received from the PUF logic module 310. As an example, for a desired application and a qualitative indication, the indication may need to indicate that the seed value is of “medium useability” or “high useability,” but not “low useability,” in order to be considered useable. As another example, for a desired application and a quantitative indication, the indication may need to indicate that the seed value has a useability score higher than a predetermined threshold score in order to be considered useable. Whether the seed value is considered useable/healthy or not may be based on whether the seed value meets one or more predetermined/predefined characteristics (e.g., repeatability, entropy). If the determination is that the seed value is not usable, the process 400 proceeds from block 440 to block 445. If the determination is that the seed value is useable, the process 400 proceeds from block 440 to block 450.

At block 445, the IC 305 is classified as having generated an unuseable seed value. The part (e.g., the IC 305) may be scrapped or reallocated. For example, the part may be reallocated for usage in situations that do not require such functionality (e.g., seed value generation functionality). In some cases, the useability of the seed value may be communicated to the die element processing equipment 115 (e.g., to facilitate reallocation of the part).

At block 450, the IC 305 receives fabrication data, such as wafer identifying information and/or a coordinate pair on that wafer from which the die element 130 containing the IC 305 was taken. The fabrication data may be received by the IC 305 via one or more of the interfaces 320 from the external equipment 350, such as from the processing equipment 115. At block 455, the IC 305 causes the received fabrication data to be stored in the non-volatile memory 330 of the IC 305. Other data may be received at this time or a later time. As an example, such data may be derived during further testing or sorting, such as speed grade. In some cases, alternative or in addition to receiving fabrication data after seed creation, fabrication data may be received by the IC 305 before seed generation.

At block 460, the IC 305 (e.g., in the ID generation module 325) creates an identifier (ID) based on the seed value and the fabrication data. In this regard, the ID generation module 325 may read or receive the fabrication data and read or receive the seed value from the PUF logic module 310 and create the identifier. In some aspects, the identifier may be generated by the ID generation module 325 using a cryptographic function that satisfies criteria, including, by way of non-limiting examples, being deterministic, pre-image resistant, and collision resistant. Some implementations may use a hash function as the cryptographic function, such as secure hash algorithm (SHA)-2 class hashes (e.g., SHA-256 or SHA-384), SHA-3 class hashes, or Whirlpool. In some cases, the identifier is not stored in the IC 305. In other cases, the identifier may be stored in the non-volatile memory 330 of the IC 305. For example, the identifier may be programmed into OTP memory of the non-volatile memory 330.

At block 465, the IC 305 provides the identifier in response to a read command received over the interface 320. As an example, the read command may be from the processing equipment 115, and the IC 305 may provide the identifier to the processing equipment 115. In some cases, the processing equipment 115 may store the fabrication data and the identifier (e.g., in the database 110). In some cases, the IC 305 (e.g., the PUF logic module 310) may be referred to as being enrolled by the processing equipment 115 once the processing equipment 115 has received the identifier from the IC 305 or once the processing equipment 115 has stored the identifier (e.g., in the database 110). In some cases, a machine-readable visual representation of the identifier may be created (e.g., by the IC 305 and/or the processing equipment 115) and applied to a package of the die element 130 on which the IC 305 is formed.

In some embodiments, prior to the process 400, the IC 305 may undergo one or more electrical tests (e.g., from/by a tester of the processing equipment 115). The IC 305 may generate test responses in response to the electrical tests. The process 400 or portions thereof may be performed by the IC 305 if the IC 305 passes the electrical test(s). For example, the IC 305 may be used to generate a seed value (e.g., block 430), generate an identifier (e.g., block 460), receive fabrication data (e.g., block 450), and/or perform other operations in the process 400 if the IC 305 passes the electrical test(s). In some cases, if the IC 305 does not pass one or more of the electrical test(s), the IC 305 may be classified as a bad die element (e.g., among the set 238 or the set 242) and may be scrapped or reallocated.

FIG. 5 depicts a flow diagram of an example process 500 for facilitating back-end processing for device identification in accordance with one or more embodiments of the present disclosure. Although the process 500 is described with reference to the system 100 of FIG. 1 that includes the die element processing equipment 115 and the die element 130 (on which an IC such as according to the IC 305 of FIG. 3 can be fabricated) for explanatory purposes, the process 500 may be performed by other systems. Further for explanatory purposes, the IC 305 is considered to be formed on the die element 130. The IC 305 may be on a die element prior to dicing of a wafer (e.g., the wafer 230), on a die element after dicing of the wafer (e.g., one of the die elements 234), on a die element after packaging (e.g., one of the packaged die elements 240 or 242), or on a die element at an intervening/intermediate stage or at a stage subsequent to packaging. One or more blocks (e.g., also referred to as operations, processes, steps, methods) may be combined, omitted, and/or performed in a different order as desired.

At block 505, the processing equipment 115 sends a command to the IC 305 to enroll the PUF logic module 310. At block 510, the IC 305 performs operations associated with generating an identifier associated with the IC 305 for enrolling the PUF logic module 310 in response to the command. Since the IC 305 is formed on the die element 130, an identifier associated with the IC 305 may also be referred to as an identifier associated with the die element 130. In some embodiments, the IC 305 formed on the die element 130 may perform the process 400 of FIG. 4 to generate the identifier. Upon completion of block 510, at block 515, the IC 305 provides a success indicator to the processing equipment 115 indicative of success in generating an identifier. In some aspects, the success indicator may include information about the operation of the PUF logic module 310, such as a relative quality score (e.g., useability/health score) for the seed value, but would not include the seed value. At block 520, the processing equipment 115 provides the fabrication data to the IC 305. In some aspects, the fabrication data is provided for storage in the non-volatile memory 330 of the IC 305. By way of non-limiting examples, such providing/provision of the fabrication data can be a programming of a non-volatile memory, such as OTP memory of the non-volatile memory 330, and/or can be a providing to an input buffer on the IC 305. In cases that the IC 305 on the die element 130 locks and unlocks its interface(s) 320 (e.g., for security purposes), the provision of the fabrication data to the IC 305 can be timed or coordinated with when the IC 305 locks and unlocks its interface(s) 320. In some cases, for implementations that lock the interface(s) 320 during both PUF enrollment (that includes the generation of the seed within the IC 305) and during ID creation, for the provision at block 520 to occur between those actions the IC 305 may allow the interface(s) 320 to receive data, but may still disable any output from the interface(s) 320. The fabrication data also can be received with or prior to the command at block 505.

At block 525, the processing equipment 115 sends a read command to the IC 305 for the identifier associated with the IC 305. In some embodiments, block 520 and/or 525 are performed by the processing equipment 115 in response to the success indicator provided by the IC 305 at block 515. At block 530, the IC 305 provides the identifier to the processing equipment 115. At block 535, the processing equipment 115 provides the fabrication data and the identifier for storing in the database 110. The constituent detailed actions for implementing such storage would depend on how the database 110 interfaces with processing equipment 115, and in some implementations could also interface with the die element 130 to directly receive this fabrication information and the ID.

In some embodiments, enrollment of each IC records an identifier of each IC to associate the IC with a specific semiconductor company (e.g., a legitimate/authorized production line of the specific semiconductor company) and mitigate effects of cloning. In some cases, other information may be recorded along with the identifier. For example, along with the identifier for a given IC, fabrication data for the IC and, in some cases, data obtained during testing of the IC (e.g., speed grading) may also be recorded. In some cases, the processing equipment 115 may be considered to have enrolled the IC 305 upon receiving the identifier from the IC 305 (e.g., after block 530). In some cases, the processing equipment 115 may be considered to have enrolled the IC 305 upon storing the identifier from the IC 305 (e.g., storing in the database 110 at block 535).

In some embodiments, the processes 400 and/or 500 may be performed by and/or with a fabricated semiconductor product. A fabricated semiconductor product may refer to a die element (e.g., the die element 130) or an IC (e.g., the IC 305) fabricated on the die element. A fabricated semiconductor product may refer to any one of various stages of a die element having an IC formed thereon or the IC itself at any one of these various stages. In this regard, a fabricated semiconductor product may refer to a die element of a wafer (e.g., the wafer 230) prior to dicing of the wafer, a die element after dicing of the wafer (e.g., one of the die elements 234), a die element after packaging (e.g., one of the packaged die elements 240 or 242), a die element at an intervening stage or at a stage subsequent to packaging, or an IC on the die element at any one of these various stages.

Integrated circuits have become increasingly complex. Entire systems are constructed from diverse integrated circuit sub-systems. Describing such complex technical subject matter at an appropriate level of detail becomes necessary. In general, a hierarchy of concepts is applied to allow those of ordinary skill to focus on details of the matter being addressed.

Describing portions of a design (e.g., different functional units within a chip, apparatus or system) according to functionality provided by those portions is often an appropriate level of abstraction, since each of these portions may themselves comprise hundreds of thousands, hundreds of millions, or more elements. When addressing some particular feature or implementation of a feature within such portion(s), it may be appropriate to identify substituent functions or otherwise characterize some sub-portion of that portion of the design in more detail, while abstracting other sub-portions or other functions.

A precise logical arrangement of the gates and interconnect (a netlist) implementing a portion of a design (e.g., a functional unit) can be specified. How such logical arrangement is physically realized in a particular chip (how that logic and interconnect is laid out in a particular design) may differ in different process technologies and/or for a variety of other reasons. Circuitry implementing particular functionality may be different in different contexts, and so disclosure of a particular circuit may not be the most helpful disclosure to a person of ordinary skill. Also, many details concerning implementations are often determined using design automation, proceeding from a high-level logical description of the feature or function to be implemented. In various cases, describing portions of an apparatus or system in terms of its functionality conveys structure to a person of ordinary skill in the art. As such, it is often unnecessary and/or unhelpful to provide more detail concerning a portion of a circuit design than to describe its functionality.

Functional modules, logic, or units may be composed of circuitry, where such circuitry may be fixed function, configurable under program control or under other configuration information, or some combination thereof. Functional modules themselves thus may be described by the functions that they perform, to helpfully abstract how some of the constituent portions of such functions may be implemented. In some situations, circuitry, units, and/or functional modules may be described partially in functional terms, and partially in structural terms. In some situations, the structural portion of such a description may be described in terms of a configuration applied to circuitry or to functional modules, or both.

Configurable circuitry is effectively circuitry or part of circuitry for each different operation that can be implemented by that circuitry, when configured to perform or otherwise interconnected to perform each different operation. Such configuration may come from or be based on instructions, microcode, one-time programming constructs, embedded memories storing configuration data, and so on. A unit or module for performing a function or functions refers, in some implementations, to a class or group of circuitry that implements the functions or functions attributed to that unit. Identification of circuitry performing one function does not mean that the same circuitry, or a portion thereof, cannot also perform other functions concurrently or serially.

Although circuitry or functional units may typically be implemented by electrical circuitry, and more particularly, by circuitry that primarily relies on transistors fabricated in a semiconductor, the disclosure is to be understood in relation to the technology being disclosed. For example, different physical processes may be used in circuitry implementing aspects of the disclosure, such as optical, nanotubes, micro-electrical mechanical elements, quantum switches or memory storage, magnetoresistive logic elements, and so on. Although a choice of technology used to construct circuitry or functional units according to the technology may change over time, this choice is an implementation decision to be made in accordance with the then-current state of technology.

Embodiments according to the disclosure include non-transitory machine readable media that store configuration data or instructions for causing a machine to execute, or for configuring a machine to execute, or for describing circuitry or machine structures (e.g., layout) that can execute or otherwise perform, a set of actions or accomplish a stated function, according to the disclosure. Such data can be according to hardware description languages, such as HDL or VHDL, in Register Transfer Language (RTL), or layout formats, such as GDSII, for example.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention. Consequently, while elements in the following method claims, if any, are recited in a particular sequence, unless the claim recitations otherwise explicate or require a particular sequence for implementing some or all of those elements, the claim is not limited to those recited elements performed in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

1. A method comprising:
receiving fabrication data associated with a die element, wherein the die element has an integrated circuit fabricated according to a design defined by a mask set;
creating, by the integrated circuit, a seed value based on a characteristic of the integrated circuit; and
producing, by the integrated circuit, an identifier for the die element based on the fabrication data and the seed value.

2. The method of claim 1, further comprising providing, by the integrated circuit, the identifier in response to a command received by the die element.

3. The method of claim 2, further comprising storing, by testing equipment coupled with the die element, the fabrication data and the identifier in a database.

4. The method of claim 1, wherein the producing comprises processing, by the integrated circuit, the fabrication data and the seed value using a cryptographic function to produce the identifier for the die element.

5. The method of claim 1, further comprising storing the fabrication data in non-volatile memory of the die element, wherein the creating of the seed value is performed by the integrated circuit using a physically unclonable function.

6. The method of claim 1, wherein the characteristic comprises a physical characteristic associated with fabrication of the integrated circuit.

7. The method of claim 6, wherein the physical characteristic is based on material deposition during fabrication of the integrated circuit.

8. The method of claim 1, further comprising:
generating, by the integrated circuit, a score based on a characteristic of the seed value, wherein the producing is based on the score;
creating a machine-readable visual representation of the identifier; and
applying the machine-readable visual representation of the identifier to a package of the die element, wherein the seed value is a high-entropy, repeatable seed value, and wherein the fabrication data is unique relative to all other die elements made from the mask set.

9. The method of claim 1, further comprising:
generating, by the integrated circuit, test results in response to an electrical testing of the die element, wherein the receiving, the creating, and the producing are performed when the integrated circuit passes the electrical testing; and
storing the test results in non-volatile memory of the die element.

10. The method of claim 1, wherein the die element and each of one or more additional die elements are from a semiconductor wafer, the method further comprising for each additional die element:
generating, by an integrated circuit of the additional die element, test results in response to an electrical testing of the additional die element;
if the additional die element passes the electrical testing:
receiving fabrication data associated with the additional die element;
creating, by the integrated circuit of the additional die element, a seed value based on a characteristic of the integrated circuit of the additional die element; and
producing, by the integrated circuit of the additional die element, an identifier for the additional die element based on the fabrication data associated with the additional die element and the seed value associated with the additional die element.

11. The method of claim 1, wherein the die element is from a semiconductor wafer, and wherein the fabrication data comprises data indicative of a location of the die element on the semiconductor wafer.

12. The method of claim 1, wherein the die element is from a semiconductor wafer, and wherein the fabrication data comprises data indicative of a wafer identifier associated with the semiconductor wafer.

13. The method of claim 1, further comprising:
activating temperature and voltage monitoring on the die element, wherein the creating and the producing are performed when the temperature and the voltage of the die element are maintained within defined ranges; and
storing the identifier in a one-time programmable memory of the die element.

14. The method of claim 1, further comprising locking all external interfaces of the integrated circuit during the creating and the producing.

15. A fabricated semiconductor product, comprising:
a non-volatile programmable memory configured to store data associated with fabrication of the semiconductor product; and
a logic circuit configured to:
create a seed value based on a characteristic of the semiconductor product; and
produce an identifier for the semiconductor product based on the data and the seed value.

16. The fabricated semiconductor product of claim 15, wherein the logic circuit is further configured to:
receive a command from equipment coupled to the fabricated semiconductor product; and
provide the identifier to the equipment in response to the command.

17. The fabricated semiconductor product of claim 15, wherein the logic circuit is further configured to monitor voltage and temperature associated with the fabricated semiconductor product, and wherein the logic circuit is configured to produce the identifier when the temperature and the voltage are within defined ranges.

18. The fabricated semiconductor product of claim 15, further comprising one or more interfaces, wherein the logic circuit is further configured to lock the one or more interfaces during creation of the seed value and producing of the identifier.

19. The fabricated semiconductor product of claim 15, wherein the fabricated semiconductor product comprises a packaged die element.

20. The fabricated semiconductor product of claim 15, wherein the characteristic comprises a physical characteristic associated with fabrication of the semiconductor product, and wherein the logic circuit is configured to:
create the seed value using a physically unclonable function; and
produce the identifier by processing the data and the seed value using a cryptographic function, wherein the data comprises data indicative of a wafer identifier associated with a semiconductor wafer on which the semiconductor product was fabricated and/or of a location of the semiconductor product on the semiconductor wafer.
